(19) United States
(12) Patent Application Publication
(10) Pub. No.: US 2012/0135378 A1
(43) Pub. Date: May 31, 2012

(54) FASTENING SCREW FOR PROSTHETIC COMPONENTS IN IMPLANTODONTICS

(76) Inventor: Geninho Thome, Curitiba-PR (BR)

(21) Appl. No.: 13/256,202

(22) PCT Filed: Mar. 12, 2010
(86) PCT No.: PCT/BR2010/000067

§ 371 Date: Feb. 3, 2012

(30) Foreign Application Priority Data
Mar. 12, 2009 (BR) MU8900506-6

(51) Int. Cl. A61C 13/00; B21H 3/02

(52) U.S. Cl. 433/167; 72/67

(57) ABSTRACT

Fastening screws for prosthetic components are provided with a thread achieved by a rolling process (thread rolling). These fastening screw are connected to the fitted screw of universal trunnion CM, angled universal trunnion CM, angled conic mini pillar CM over the dental implant CM (Morse Cone system) intraorally placed. The screw can be used in a variety of prosthetic components line for CM dental implants (Morse Cone system) and other implants lines (outer hexagon, inner hexagon, etc.). The screw made by the rolled thread process provides stronger screws that can be used to fasten prosthetic components onto various dental implants.

The subject utility model patent application concerns with the manufacturing of fastening screw for prosthetic components with a thread achieved by a rolling process (thread rolling), or by any process of achieving a thread that is similar and has as a basic conception the cold forming of the material.

### BACKGROUND

There has been identified in the state of art that for this use there only exist some machined-thread screws or screws with separated bodies so the rod and the thread bushing have a weld made, according to document U.S. Pat. No. 5,674,072, for forming the fastening screw mounted on an universal trunnion CM, thus giving rise to the drawbacks of easy breakdown of the fastening screw during prosthetic laboratory tasks and prosthetic component clinic installing. There exist several documents in the state of art that are related to the subject matter, although all made by conventional processes or with the need of implementation of adapters, such as the patent applications PI 0113859-6, titled “APOIO PARA IMPLANTE DENTÁRIO E COMPONENTES ASSOCIADOS PARA USO COM O MESMO”, filed on Sep. 12, 2001; this application claims a support that is placed in the bone comprising the mounting portion so an implant is received. This mounting portion further presents a mini pillar formed with the thread for a threaded coupling to the implant thread and a locking tapering. WO 910213, titled “ARTIFICIAL DENTAL ROOT” filed on Aug. 29, 1990, concerns with an artificial dental root that is to be implanted, which is made with a rolled metallic core and covered with ceramics, the main body and upper structure of which are separable. MU 8303001-8 U, titled “DISPOSIçÃO INTRODUZIDA EM ADAPTADOR INTERMEDIÁRIO PARA IMPLANTES DENTÁRIOS”, filed on Nov. 17, 2003 concerns with an intermediate adapter that is placed between the trunnion and the threaded implant and is internally hollow in a way that the fastening screw passes it over. This product has been developed aiming at making the trunnions maintenance and replacement more versatile.

### OBJECT OF THE INVENTION

The object of the subject utility model patent application is to provide a fastening screw for prosthetic components that come to eliminate above-shown troubles.

### DESCRIPTION OF THE DRAWINGS

FIG. 1 shows a perspective view of the fastening screw with respective trunnions;

FIG. 2 shows a front view of the fastening screw with respective trunnions;

FIG. 3 shows a section front view of the fastening screw with respective trunnions.

### DETAILED DESCRIPTION OF THE INVENTION

The subject fastening screw of said utility model is used to the fastening of a trunnion such as: fitted screw of universal trunnion CM, angled universal trunnion CM, angled conic mini pillar CM over the dental implant CM (Morse Cone system) intraorally placed, its use also extending to all the prosthetic components line for CM dental implants (Morse Cone system) and other implants lines (outer hexagon, inner hexagon, etc.). It will be used in all the cases of fastening prosthetic components over the dental implants whatever the need will be of applying the rolled thread process.

The fastening screw for fitted screw universal trunnion CM and the angled universal trunnion CM is machined from ASTM F136 biocompatible titanium available as a non-sterile form for single use.

The fastening screw is provided mounted in trunnions such as the fitted screw universal trunnion CM, the angled universal trunnion CM and the angled conic mini pillar CM and packed in a blister package (surgical grade film and paper) available as single units on the market as a fastening screw/universal trunnion CM assembly.

The respective fastening screw, the patent object of subject utility model, is characterized in that it has a thread achieved by the rolling process (thread rolling) that is to be used together with the fitted screw universal trunnion CM, the angled universal trunnion CM or the angled conic mini pillar CM, thus figuring as a new product on the fellow market and bringing several benefits about in its use.

The present improvement is alto characterized in that the thread technology achieved by the rolling process (thread rolling) offers greater strength to the torque application upon the installation of universal trunnion CM and other prosthetic components used in implantodontics, thus obviating the drawbacks of easy breakdown of the fastening screw during prosthetic laboratory tasks and prosthetic component clinic installing, thus improving the insert process of same on the dental implant.

Accordingly, the fact that the fastening screw with a thread achieved by the rolling process (thread rolling) for fastening the fitted screw fastening screw, the angled universal trunnion CM and the angled conic mini pillar CM, the object of subject utility model, has a thread achieved by-pass the rolling process instead of the machining process or by the welding joint of thread and rod, presents greater breaking strength and avoids the drawbacks in the universal trunnion CM installation, thus bringing about a greater quality to the installation process and bigger stability between the implant and the subject prosthetic component (the fitted screw universal trunnion CM, the angled universal trunnion CM and the angled conic mini pillar CM). Furthermore, said rolling process increases the fastening screw strength to the torque application upon the prosthetic components over dental implants for it is a single piece and do not need a weld to the union of the thread and screw body, giving more safety since there is no risk of thread weld breaking and consequently loosing the prosthetic component inside de mouth. Said process also enables a lower hole diameter in the prosthetic component so the fastening screw can pass, if it is of single body type, thus providing a bigger mechanic strength to the prosthetic component.

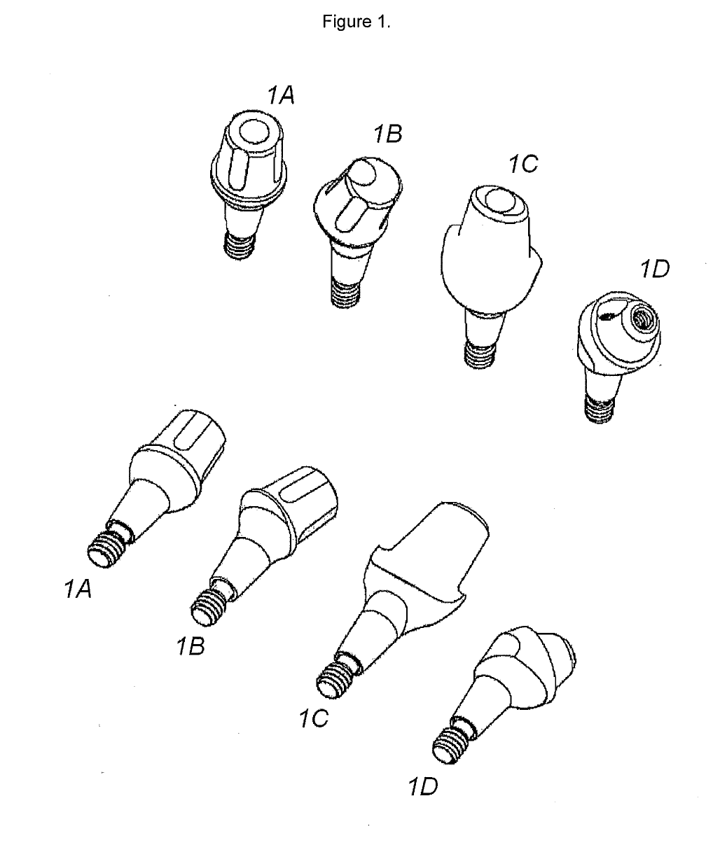

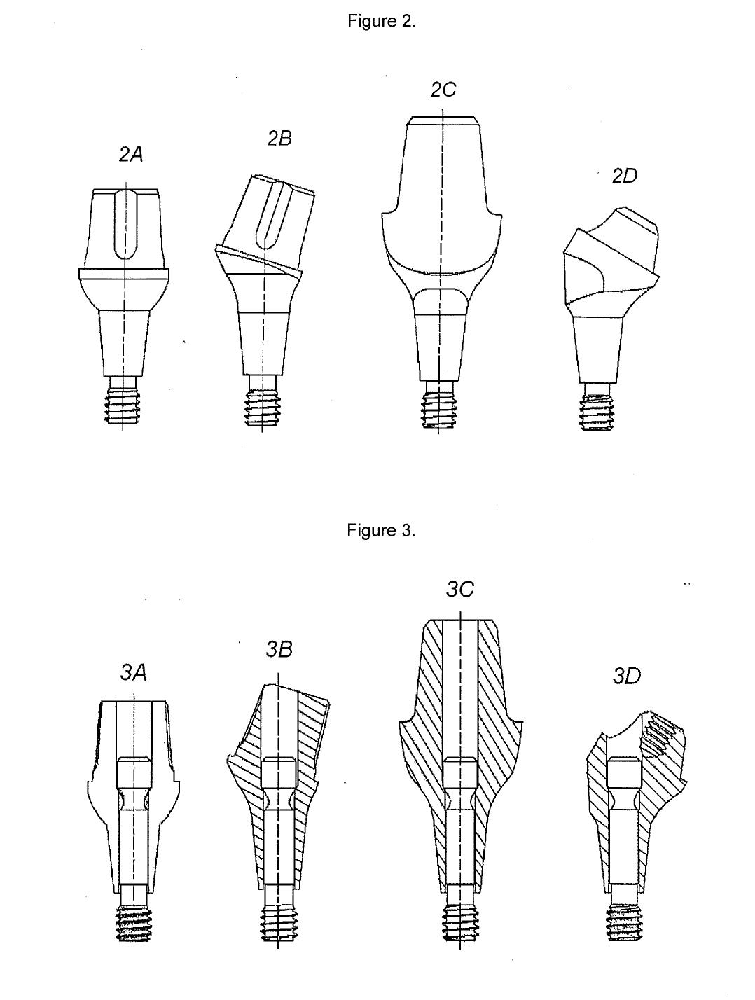

Aiming at a better understanding of arrangements when applied to the subject improvement, FIG. 1 shows a perspective view of the fastening screw provided with a thread achieved by a rolling process, and already mounted on the fitted screw universal trunnion CM (1A), the fastening screw provided with a thread achieved by a rolling process, and already mounted on the angled universal trunnion CM (1B), the fastening screw provided with a thread achieved by a rolling process, and already mounted on the angled anatomic universal trunnion CM (1C); or the fastening screw provided with a thread achieved by a rolling process, and already mounted on the angled conic mini pillar CM (1D). FIG. 2 shows a front view of the fastening screw provided with a thread achieved by a rolling process, and already mounted on the fitted screw universal trunnion CM (2A), the fastening screw provided with a thread achieved by a rolling process, and already mounted on the angled universal trunnion CM (2B), the fastening screw provided with a thread achieved by a rolling process, and already mounted on the angled anatomic universal trunnion CM (2C); or the fastening screw provided with a thread achieved by a rolling process, and already mounted on the angled conic mini pillar CM (2D). FIG. 3 illustrates in front view, although in section, the fastening screw provided with a thread achieved by a rolling process, and already mounted on the fitted screw universal trunnion CM (3A), the fastening screw provided with a thread achieved by a rolling process, and already mounted on the angled universal trunnion CM (3B), the fastening screw provided with a thread achieved by a rolling process, and already mounted on the angled anatomic universal trunnion CM (3C); or the fastening screw provided with a thread achieved by a rolling process, and already mounted on the angled conic mini pillar CM (3D).

It suits to clarify that the hereby presented model is illustrated in a demonstrative not limitative way, which conception can be variable as measures, said enhancement can also be subject to diversifications as its dimensions and materials, without logically deviating from the main inventive scope of the object which protection is claimed.

In this way, the utility model patent concerns with a fastening screw provided with a thread achieved by a rolling process (1), provided together with a fitted screw universal trunnion CM (2) or with an angled universal trunnion CM (3) which provides bigger torque strength on prosthetic components installation thus giving more efficacy and quality to the installing process.

Previously-given examples are non-limitative to the scope of subject utility model and other uses will become apparent from those presently described. In the same way, others conceptions comprising variations and modifications of subject utility model will became obvious from those presently described, although such variations and modifications are included in subject utility model scope.

1. A fastener for prosthetic components comprising a screw comprising thread rolled threads and a trunnion.

2. The fastener according to claim 1, where the trunnions are selected from the group consisting of fitted screw universal trunnion CM, angled universal trunnion, angled anatomic universal trunnion CM and angled conic mini pillar CM.

3. A fastening screw for prosthetic components comprising thread rolled threads, wherein the screw is a single piece.

4. (canceled)

5. A prosthetic device comprising a fastener of claim 1 and a prosthetic component, said prosthetic component connected to the screw by a whole in the prosthetic component.

6. A method of manufacturing a fastener for prosthetic components, the method comprising forming threads on the fastener by thread rolling.
